(19) United States
(12) Patent Application Publication
(10) Pub. No.: US 2006/0113229 A1
(43) Pub. Date: Jun. 1, 2006

(54) Water management system

(75) Inventor: Michael N. Galijan, Keilor (AU)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Intray Consolidated Pty Ltd, Keilor (AU)

(21) Appl. No.: 11/000,559

(22) Filed: Dec. 1, 2004

(51) Int. Cl. B01D 36/00

(52) U.S. Cl. 210/167; 210/172

(57) ABSTRACT

A water management system for a concrete batching plant, the system includes a plant operations area including one or more surfaces sloped so that surface water within the plant operations area runs to a single collection point, a water catchment pit for collecting water at the single collection point, and water recycling apparatus for returning water held in the water catchment pit to the concrete batching plant for reuse.

### FIELD OF THE INVENTION

The present invention relates to a water management system. Particularly, the present invention relates to a water management system for concrete batching plants.

### BACKGROUND OF THE INVENTION

Concrete batching plants must adhere to strict statutory requirements regarding the control of environmental conditions. One area that requires particular attention is water use and waste within the concrete batching plant.

A large amount of water is used in concrete batching plants. Water is required to be added to dry concrete ingredients when supplied to an agitator and is also used to wash excess concrete from the inside and outside of the agitators used to transport batched concrete. A large amount of water is wasted and a large amount of fresh water is required regularly in existing concrete batching plants.

It would be desirable to provide a water management system for a concrete batching plant that is simple, efficient and minimises water wastage in concrete batching plants.

### SUMMARY OF THE INVENTION

An embodiment of the present invention provides a water management system for a concrete batching plant, including a plant operations area including one or more surfaces sloped so that surface water within the plant operations area runs to a single collection point, a water catchment pit for collecting water at the single collection point, and water recycling apparatus for returning water held in the water catchment pit to the concrete batching plant for reuse.

Advantageously, the water management system further includes one or more water storage tanks for storing water recovered by the water catchment pit.

Advantageously, the water catchment pit includes filtration apparatus for separating water held in the water catchment pit from particulate matter in that water. The filtration apparatus many include an interconnected series of recipients, each recipient including a lower portion in which particulate matter in the water settles and a water transfer system for transferring water from an upper portion of each recipient to a downstream recipient. Preferably, the water storage tanks receive water directly from the filtration apparatus.

Preferably, the water management system further includes stirring apparatus for maintaining in suspension particulate matter in the water recovered by the water catchment pit prior to reuse in the concrete batching plant. The stirring apparatus may include a stirrer pit for receiving water recovered by the water catchment pit and a stirrer for stirring water in the stirrer pit. Preferably, the stirrer pit is adapted to receive water from the water catchment pit when the water storage tanks reach a predetermined level.

There may further be included water discharge apparatus located within the plant operations area, wherein the water discharge apparatus act to discharge excess water onto the one or more surfaces. The water discharge apparatus may include one or more agitator washing devices. The agitator washing devices are preferably associated with one or more slump stands. The agitator washing devices may also be associated with one or more agitator washing stations.

Preferably, the water recycling apparatus include a first water supply system for supplying the water discharge apparatus with water from the water stirrer pit. The water recycling apparatus may include a second water supply system for supplying water to a batching area in the concrete batching plant.

Preferably, the plant operations area contains concrete batching apparatus for loading aggregate into agitators and at least part of an aggregate supply apparatus for supplying aggregate to the concrete batching apparatus.

### BRIEF DESCRIPTION OF THE DRAWINGS

The invention will now be described, by way of example only, with reference to the accompanying drawings, in which:

FIG. 1 shows a plan view of a concrete batching plant incorporating the water management system of the present invention;

FIG. 2 shows a flow diagram of the water management system of FIG. 2; and

FIG. 3 shows a cross-sectional view of a filtration apparatus.

### DETAILED DESCRIPTION OF ILLUSTRATIVE EMBODIMENTS

Concrete is made of a number of mixture ingredients, including aggregate, such as sand and gravel, cement and water. Aggregate is stored in an aggregate storage area 4 and is transported to an aggregate storage area 6 within a concrete batching apparatus 8, via an aggregate supply apparatus such as conveyor 9. Cement is stored in silos 11 and water is stored in a water tank (not shown) within the concrete batching apparatus 8. An agitator is loaded with the mixture ingredients within an agitator loading zone of the concrete batching apparatus 8.

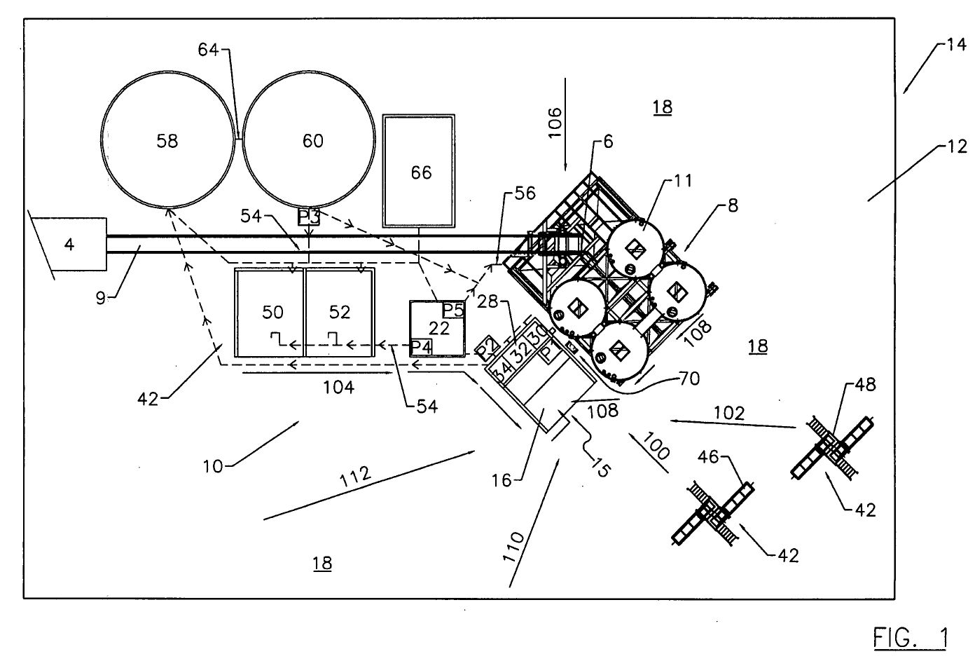

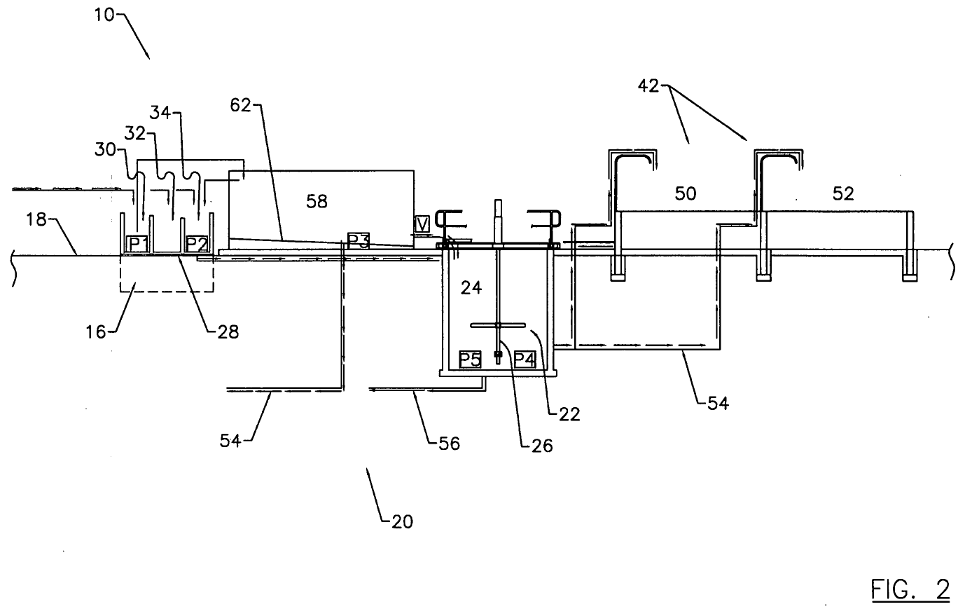

A water management system 10 for a concrete batching plant 14 is shown in FIG. 1. The system 10 includes a plant operations area 12 that includes one or more sloped surfaces 18 so that surface water within the plant operations area 12 runs to a single collection point 15, and a water catchment pit 16 for collecting water at the single collection point 15. The system 10 also includes water recycling apparatus 20, as shown in FIG. 2, for returning water held in the water catchment pit 16 to the concrete batching plant 14 for reuse.

The single collection point 15 is located at the lowest point of the surface 18 of the plant operations area 12. The surface 18 is sloped so that all water runs to the single collection point 15 and into the water catchment pit 16.

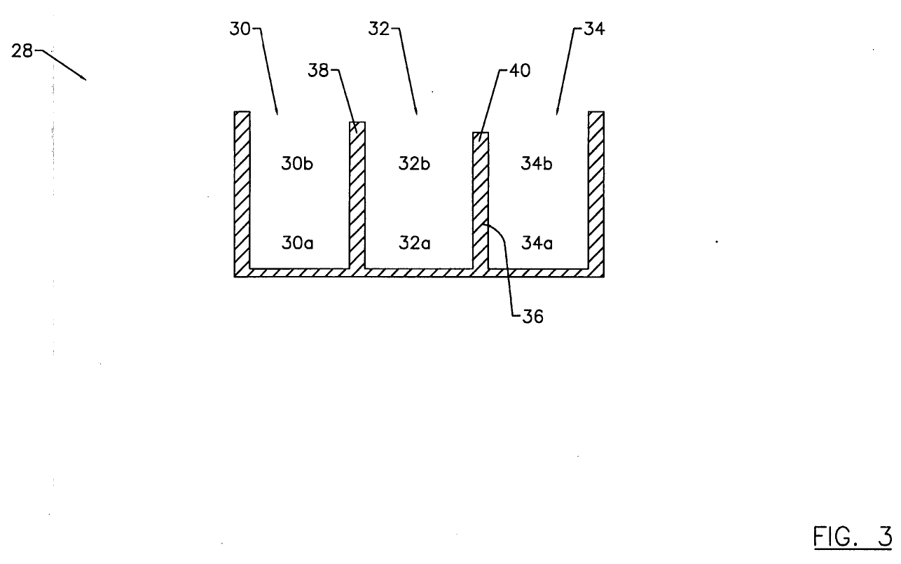

The water catchment pit 16 includes filtration apparatus 28 for separating water held in the water catchment pit 16 from particulate matter in that water. As shown in FIG. 3, the filtration apparatus 28 includes an interconnected series of recipients 30, 32, 34, each recipient 30, 32, 34 including a lower portion 30a, 32a, 34a in which particulate matter in the water settles. There is also a water transfer system 36 for transferring water from an upper portion 30b, 32b, 34b of each recipient 30, 32 to a downstream recipient 32, 34.

The water transfer system 36 includes two walls 38, 40 located respectfully between recipient 30 and 32 and between recipients 32 and 34. The water from the water catchment pit 16 is pumped into recipient 30 by pump P1. When recipient 30 is full, water flows over wall 38 and into recipient 32, leaving settled particulate matter in the lower portion 30a of recipient 30. When recipient 32 is full, water flows over wall 40 and into recipient 34, leaving a further amount of settled particulate matter in the lower portion 32 of recipient 32. The water that leaves recipient 34 is significantly cleaner than the water that entered recipient 30, as the particulate matter has settled in lower portions 30a, 32a, 34a. The recipients 30, 32, 34 are cleaned out regularly to remove the settled particulate matter.

The system 10 includes two water storage tanks 58, 60 for storing water recovered by the water catchment pit 16. Water from the recipient 34 is pumped into the water storage tank 58 by pump P2 following filtration through the filtration apparatus 28. The floor 62 of one of the water storage tanks 58 is sloped, and a pipe 64 joins the two water storage tanks 58, 60, such that the amount of water in the two water storage tanks evens out and the particulate matter settles on the floor 62.

The system 10 also includes a stirring apparatus 22 for maintaining in suspension particulate matter in the water recovered by the water catchment pit 16, prior to reuse in the concrete batching plant 14. The stirring apparatus 22 includes a stirrer pit 24 for receiving water from the water storage tank 60, and a stirrer 26 for stirring water in the stirrer pit 24. When the water storage tanks 58, 60 are full or the stirrer pit 24 is low, water is released straight from the recipients 30, 32, 34 into the stirrer pit 24.

The system 10 includes water discharge apparatus 42 located within the plant operations area 12, the water discharge apparatus 42 acting to discharge excess water onto the one or more surfaces 18. The water discharge apparatus 42 includes two agitator washing devices 44. The agitator washing devices are associated with two slump stands 46, 48. After an agitator is loaded with mixture ingredients, it drives to a slump stand 46, 48 and is filled with the appropriate amount of water to make the correct concrete consistency. The agitator then sits and mixes the concrete for a period of time. The driver may also wash the outside of the agitator at the slump stand 46, 48. It will be appreciated that there may be any number of slump stands 46, 48 within a plant operations area 12, and each has an amount of water which is discarded to the surface 18 of the plant operations area 12. The discarded water is conveyed to the water catchment pit 16 due to the slope of the surface 18 of the plant operations area 12, as shown by arrows 100, 102.

The agitator washing devices 44 are associated with two agitator washing stations 50, 52, which is where the inside of the agitators are washed out. The majority of the water used during the washing out of the agitators is captured within the agitator washing stations 50, 52. However, some of the water is discarded on the surface 18. The water in the agitator washing stations 50, 52 is filtered out, leaving particulate matter in the agitator washing station 50, 52, which is periodically cleaned out. The water discarded on the surface 18 is conveyed to the water catchment pit 16, via the slope of the surface 18 as shown by arrows 104. The surface 18 may also include drains, for assisting the surface water to run to the water catchment pit 16. The water which is filtered out of the agitator washing stations 50, 52 is also conveyed to the water catchment pit 16.

Rainwater collected on the ground of the plant batching area also runs into the water catchment pit 16 due to the slope of the surface 18, as shown by arrows 106, 108, 110, 112. The surface 18 is sloped so that water runs past the plant batching area 8 as shown by arrow 108 and collects particulate matter surrounding the base of the concrete batching apparatus 8. The particulate matter and water then runs into water catchment pit 16. A storage area 66 for storing additives and chemicals is also located within the plant operations area 12. Any excess water from cleaning out the storage area 66 also runs into the water catchment pit 16.

The water recycling apparatus 20 includes a first water supply system 54 for supplying the water discharge apparatus 42, with water from the water stirrer pit 24 or the water storage tanks 58, 60. The water recycling apparatus 20 also includes a second water supply system 56 for supplying water to the concrete batching apparatus 8 in the concrete batching plant 14. The water is pumped out of the water storage tank 60 by pump P3. Water is pumped from the stirrer pit to the agitator washing stations 50, 52 by pump P4 and to the concrete batching apparatus by pump P5.

The first and second water supply systems 54, 56 are a series of pipes, which pump the water back to the water discharge apparatus 42 and the concrete batching apparatus 8 for reuse. As the majority of the ground water is captured and recycled, only a small amount, if any, of fresh water is required.

The system 10 also includes an upstream diversion system 70. When all water storage capacity is full, which may occur in the case of excess surface water during or after rain, a sensor opens up diversion pipes (not shown). The diversion pipes convey the excess water out of the plant operations area 12. The outlet to the upstream diversion system 70 is located adjacent, but on higher ground than, the water catchment pit 16. Water ponds out of the water catchment pit 16 and then excess water enters the upstream diversion system 70. The system 70 prevents excess water building up in the plant operations area 12 and contaminating the concrete batching plant 14.

It will be appreciated that each of the apparatus within the plant operations area 12 can be fitted with sensors and camera's, such that all of system 10 can be monitored and controlled from within a control room (not shown).

The advantages of the water management system 10 are that a significant amount of surface water is recovered and reused, such that little or no fresh water is required. The system not only captures excess water from water discharge apparatus 42, but also rainwater. The system 10 is simple and easy to run and maintain.

It will be understood that the invention disclosed and defined in this specification extends to all alternative combinations of two or more of the individual features mentioned or evident from the text or drawings. All of these different combinations constitute various alternative aspects of the invention.

Although the present invention has been described with reference to preferred embodiments, workers skilled in the art will recognize that changes may be made in form and detail without departing from the spirit and scope of the invention.

What is claimed is:

1. A water management system for a concrete batching plant, including:
a plant operations area including one or more surfaces sloped so that surface water within the plant operations area runs to a single collection point;
a water catchment pit for collecting water at the single collection point; and
water recycling apparatus for returning water held in the water catchment pit to the concrete batching plant for reuse.

2. A water management system according to claim 1, and further including:
one or more water storage tanks for storing water recovered by the water catchment pit.

3. A water management system according to claim 1, wherein the water catchment pit includes filtration apparatus for separating water held in the water catchment pit from particulate matter in that water.

4. A water management system according to claim 3, wherein the filtration apparatus includes an interconnected series of recipients, each recipient including a lower portion in which particulate matter in the water settles and a water transfer system for transferring water from an upper portion of each recipient to a downstream recipient.

5. A water management system according to claim 4, and further including one or more water storage tanks for storing water recovered by the water catchment pit, wherein the water storage tanks receive water directly from the filtration apparatus.

6. A water management system according to claim 1, and further including stirring apparatus for maintaining in suspension particulate matter in the water recovered by the water catchment pit prior to reuse in the concrete batching plant.

7. A water management system according to claim 6, wherein the stirring apparatus include a stirrer pit for receiving water recovered by the water catchment pit and a stirrer for stirring water in the stirrer pit.

8. A water management system according to claim 7, and further including one or more water storage tanks for storing water recovered by the water catchment pit, wherein the stirrer pit is adapted to receive water from the water storage tanks.

9. A water management system according to claim 7, and further including one or more water storage tanks for storing water recovered by the water catchment pit, wherein the stirrer pit is adapted to receive water from the water catchment pit when the water storage tanks reach a predetermined level.

10. A water management system according to claim 1, and further including water discharge apparatus located within the plant operations area, wherein the water discharge apparatus act to discharge excess water onto the one or more surfaces.

11. A water management system according to claim 10, wherein the water discharge apparatus include one or more agitator washing devices.

12. A water management system according to claim 11, wherein the agitator washing devices are associated with one or more slump stands.

13. A water management system according to claim 11, wherein the agitator washing devices are associated with one or more agitator washing stations.

14. A water management system according to claim 10, wherein the stirring apparatus include a stirrer pit for receiving water recovered by the water catchment pit and the water recycling apparatus include a first water supply system for supplying the water discharge apparatus with water from the water stirrer pit.

15. A water management system according to claim 10, wherein the water recycling apparatus include a second water supply system for supplying water to a batching area in the concrete batching plant.

16. A water management system according to claim 1, wherein the plant operations area comprises concrete batching apparatus for loading aggregate into agitators and at least part of an aggregate supply apparatus for supplying aggregate to the concrete batching apparatus.
